(19) United States
(12) Patent Application Publication
(10) Pub. No.: US 2025/0202326 A1
(43) Pub. Date: Jun. 19, 2025

(54) MANUFACTURING METHOD OF COIL AND MANUFACTURING METHOD OF COIL UNIT

(71) Applicant: ASTER CO., LTD., Akita (JP)

(72) Inventor: Takenobu HONGO, Fukushima (JP)

(21) Appl. No.: 18/846,423

(22) PCT Filed: Feb. 3, 2023
(86) PCT No.: PCT/JP2023/003612

§ 371 Date: Sep. 12, 2024

(30) Foreign Application Priority Data
Mar. 30, 2022 (JP) 2022-054911
Mar. 30, 2022 (JP) 2022-054912

(51) Int. Cl. H02K 15/043; B23P 19/02; H02K 15/122

(52) U.S. Cl. CPC H02K 15/0431; B23P 19/02; H02K 15/122

(57) ABSTRACT

A manufacturing method of a coil includes: a step of winding a round wire conductor to form a round wire coil; and a step of pressing the round wire coil with a molding metal mold to form a flat square wire coil having one turn in a substantially rectangular shape.

### CROSS REFERENCE TO RELATED APPLICATIONS

This application is a 371 U.S. National Phase of International Application No. PCT/JP2023/003612, filed on Feb. 3, 2023, which claims priority to Japanese Patent Application No. 2022-054911, filed Mar. 30, 2022 and Japanese Patent Application No. 2022-054912, filed Mar. 30, 2022. The entire disclosures of the above applications are incorporated herein by reference.

### BACKGROUND

### Technical Field

The present invention relates to a manufacturing method of a coil and a manufacturing method of a coil unit.

### Related Art

Conventionally, concentrated-winding flat square wire coils have been used as motor components. As a manufacturing method of coils suitably used for a motor, there is known a method of pressure-welding each end of a plurality of coil pieces. With the flat square wire coils, the space factor can be improved when the coils are attached to stators and, as a result, high motor output and performance can be achieved.

However, in the case of, for example, coils adopted for a small and lightweight motor, the size of the coils also becomes small, and therefore a method in which coil pieces are held with chucks and pressure-welded as disclosed in Japanese Patent No. 5592554 causes a problem of poor handling performance.

Particularly when coils for a motor are mounted onto (attached to) the motor (stator), it is essential to connect the coils to each other and to connect the coils with external connection members (such as terminals and bus bars). Conventionally, such connection has been made by, for example, welding or screwing. However, such connection (operation) becomes difficult when the coil size is small.

Moreover, while motors used in, for example, electric vehicles are required to have high output and high performance, high productivity (mass production speed) may be desired more than the high output and high performance depending on the application of the motors.

In view of these problems, an object of the present invention is to provide, with regards to a coil and a coil unit that are suitable for use in a motor, a manufacturing method of a coil and a manufacturing method of a coil unit that are capable of improving productivity.

### SUMMARY

The present invention relates to a manufacturing method of a coil, including: a step of winding a round wire conductor to form a round wire coil; and a step of pressing the round wire coil with a molding metal mold to form a flat square wire coil having one turn in a substantially rectangular shape.

The present invention also relates to a manufacturing method of a coil unit, including: a step of winding a conductor to form a first-shape coil unit including a coupling portion and a plurality of first-shape coils that have been coupled through the coupling portion; and a step of pressing the first-shape coil unit with a molding metal mold to form a second-shape coil unit including a plurality of second-shape coils joined continuously.

### Advantageous Effects of Invention

The object of the present invention is to provide, with regards to a coil and a coil unit that are suitable for use in a motor, a manufacturing method of a coil and a manufacturing method of a coil unit that are capable of improving productivity.

### BRIEF DESCRIPTION OF THE DRAWINGS

FIG. 1 is a flowchart showing an example of a manufacturing method of a coil according to a present embodiment.

FIGS. 2(A)-2(D) include schematic diagrams illustrating a coil according to the present embodiment, in which FIG. 2(A) is an appearance view of a conductor as a material, FIG. 2(B) is a front (plan) view of the coil, FIG. 2(C) is a cross-sectional view of the coil, and FIG. 2(D) is a cross-sectional view of the coil.

FIGS. 3(A)-3(D) include schematic diagrams showing an example the manufacturing method of a coil according to the present embodiment, in which FIG. 3(A) is a cross-sectional view, FIG. 3(B) is a plan view, FIG. 3(C) is a cross-sectional view, and FIG. 3(D) is a plan view.

FIGS. 4(A)-4(E) include schematic diagrams showing an example of the manufacturing method of a coil according to the present embodiment, in which FIG. 4(A) is a cross-sectional view, FIG. 4(B) is a plan view, FIG. 4(C) is a cross-sectional view, FIG. 4(D) is a plan view, and FIG. 4(E) is an external perspective view.

FIGS. 5(A)-5(D) include schematic diagrams showing an example of the manufacturing method of a coil according to the present embodiment, in which FIG. 5(A) is a cross-sectional view, FIG. 5(B) is a cross-sectional view, FIG. 5(C) is a cross-sectional view, and FIG. 5(D) is a plan view.

FIGS. 6(A)-6(C) include schematic diagrams showing an example of the manufacturing method of a coil according to the present embodiment, in which FIG. 6(A) is a cross-sectional view, FIG. 6(B) is a cross-sectional view, and FIG. 6(C) is a cross-sectional view.

FIGS. 7(A)-7(C) include schematic diagrams showing an example of the manufacturing method of a coil according to the present embodiment, in which FIG. 7(A) is a cross-sectional view, FIG. 7(B) is a cross-sectional view, and FIG. 7(C) is a cross-sectional view.

FIGS. 8(A) and 8(B) include schematic diagrams showing an example of a coil unit according to a present embodiment, in which FIG. 8(A) is a top view, and FIG. 8(B) is a front view.

FIG. 9 is a flowchart showing an example of a manufacturing method of a coil unit according to the present embodiment.

FIGS. 10(A) and 10(B) include schematic diagrams showing an example of the manufacturing method of a coil unit according to the present embodiment, in which FIG. 10(A) is a plan view, and FIG. 10(B) is a top view.

FIGS. 11(A) and 11(B) include schematic diagrams showing an example of the manufacturing method of a coil unit according to the present embodiment, in which FIG. 11(A) is a plan view, and FIG. 11(B) is a plan view.

FIGS. 12(A)-12(E) are schematic diagrams showing an example of the manufacturing method of a coil unit according to the present embodiment.

FIGS. 13(A) and 13(B) are schematic diagrams showing an example of the manufacturing method of a coil unit according to the present embodiment.

FIGS. 14(A)-14(C) include schematic diagrams showing an example of the manufacturing method of a coil unit according to the present embodiment, in which FIG. 14(A) is a top view, FIG. 14(B) is a plan view, and FIG. 14(C) is a plan view.

FIGS. 15(A) and 15(B) include schematic diagrams showing an application example of the coil unit according to the present embodiment, in which FIG. 15(A) is a top view, and FIG. 15(B) is a perspective view.

FIGS. 16(A)-16(D) are cross-sectional views showing examples of the coil or the coil unit according to the present embodiment.

### DETAILED DESCRIPTION

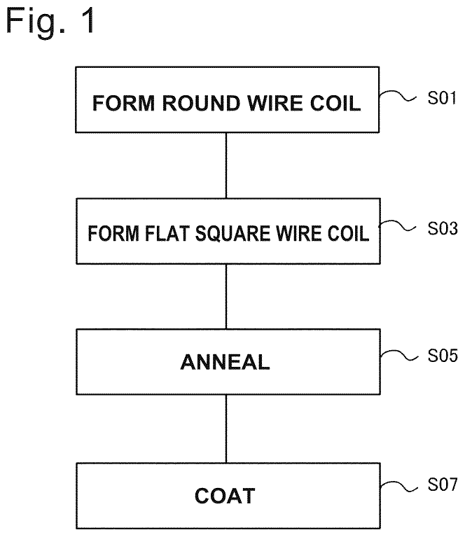

Hereinafter, embodiments of the present invention will be described in detail with reference to the drawings. In FIG. 1 and subsequent drawings, some of the configurations will be omitted as appropriate to simplify the drawings. In FIG. 1 and subsequent drawings, the size, shape, thickness, etc., of members will be expressed in an exaggerated manner as appropriate.

### First Embodiment

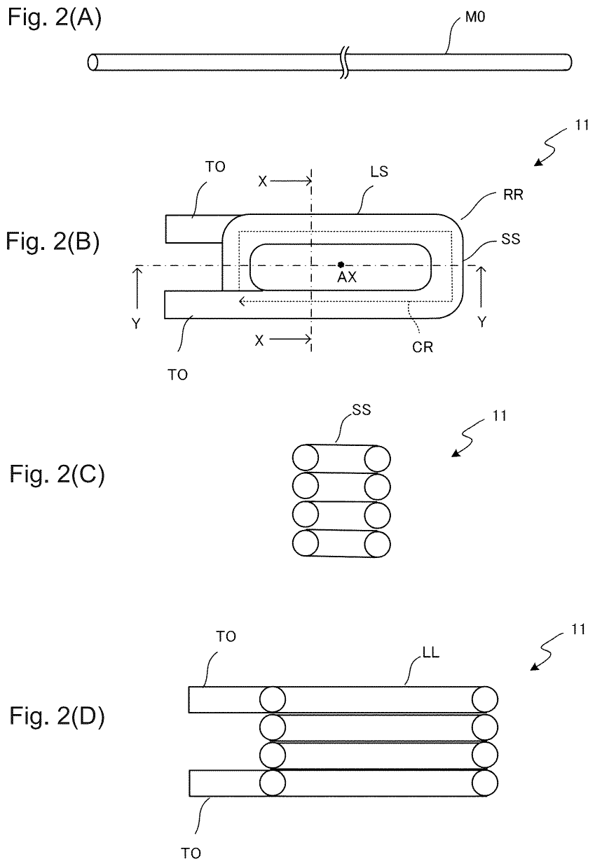

A description will now be given of a first embodiment of the present invention with reference to FIG. 1 to FIGS. 7(A)-7(C). FIG. 1 is a flowchart showing an example of a manufacturing method of a coil according to the first embodiment of the present invention. FIGS. 2 to 7 are schematic diagrams to illustrate examples of the manufacturing method of a coil of the first embodiment.

First, with reference to FIG. 1, the manufacturing method of a coil of the present embodiment includes a step of forming a round wire coil (step S01), a step of forming a flat square wire coil (step S03), an annealing step (step S05), and a coating step (step S07).

### Step of Forming Round Wire Coil (Step S01)

FIGS. 2(A)-2(D) include explanatory views of a round wire coil 11 in the present embodiment. Herein, FIG. 2(A) is an appearance view of a conductor (metal wire member) that serves as a material, FIG. 2(B) is a front view of the round wire coil as viewed from the direction of a virtual axis AX, FIG. 2(C) is a cross-sectional view taken along line X-X of FIG. 2(B), and FIG. 2(D) is a cross-sectional view taken along line Y-Y of FIG. 2(B).

As shown in FIG. 2(A), the coil is made of, for example, a long-length conductor M0. In more detail, a metal wire (round wire conductor) M0, for example, has a substantially round-shaped cross section that is orthogonal to a longitudinal (long-length) direction. As an example, the round wire conductor M0 is a metal wire mainly made of aluminum. The metal wire mainly made of aluminum is a metal wire constituted of aluminum or an aluminum alloy and is, for example, a metal line-shaped material containing 50% or more aluminum or aluminum alloy.

As shown in FIGS. 2(B) to 2(D), the round wire conductor M0 is first wound in a helical shape to form a round wire coil 11. The round wire coil 11 is a so-called concentrated winding coil, which is a helical structure body formed by winding the round wire conductor M0 around a given virtual axis AX and continuously stacking regions corresponding to one turn (hereinafter referred to as “one-turn regions CR”) of the round wire conductor M0 so as to be overlapped in an extending direction of the virtual axis AX. The virtual axis AX is a helical (coil) axis, which is hereinafter referred to as a helical axis AX. A region where a plurality of one-turn regions CR overlap each other and constitute the helical structure is referred to as a coil winding region.

The round wire coil 11 is a coil that is not subjected to any specific (intentional) molding, such as forming a right-angle corner, other than the winding of the round wire conductor M0. For example, the round wire coil 11 is wound so that the shape in planer view shown in FIG. 2(B) is substantially a rectangular shape having curved corners (with rounded corners), for example. Specifically, in this example, the round wire coil 11 is molded so as to have shorter sides SS, longer sides LS, and curved corner portions RR as a region for one turn (one-turn region CR) of the winding (helix) of the round wire coil 11. Note that, although a coil wound in a substantially rectangular shape with round corners in plan view (FIG. 2(B)) is illustrated as the round wire coil 11. However, the round wire coil 11 is not limited to this and may be any coil obtained by winding the round wire conductor M0. In other words, the round wire coil 11 in plan view may have a (substantially) elliptic shape or a (substantially) oval shape without the curved corner portions RR. For example, in the case of manufacturing the coil to be attached to a stator as a component of a motor, the round wire coil 11 is preferably wound into a shape that is long in one direction in plan view. In this example, as shown in FIGS. 2(B) to 2(D), the round wire coil 11 is molded so as to have the shorter sides SS, the longer sides LS, and the curved corner portions RR as one-turn region CR. Here, as an example, both ends of the round wire coil 11 are positioned outside the helical winding region (region where the one-turn regions CR overlap) as lead-out portions TO.

### Step of Forming Flat Square Wire Coil (Step S03)

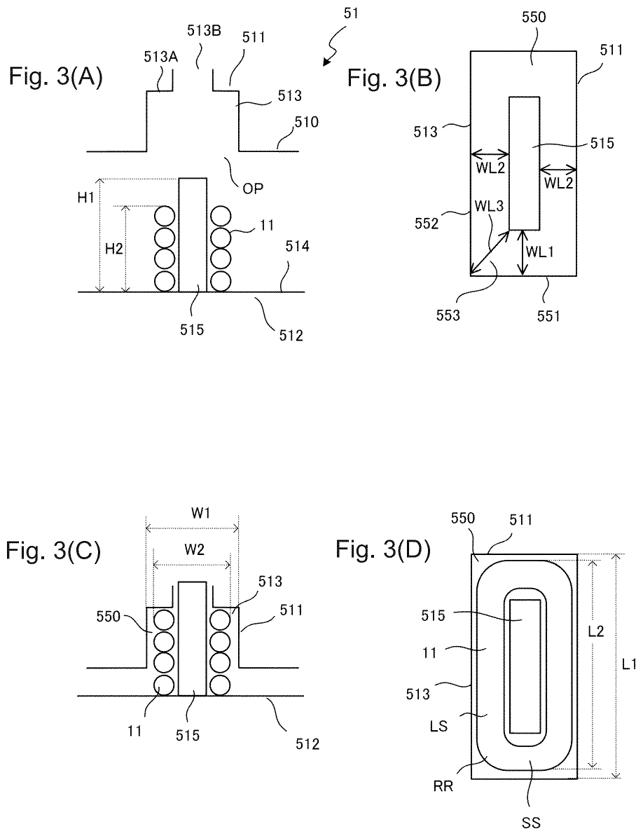

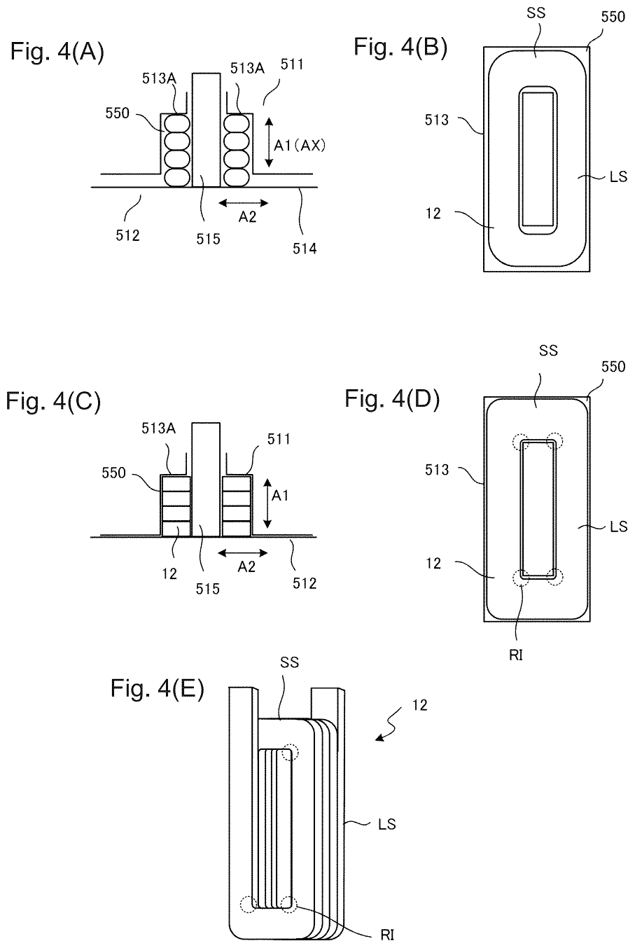

Next, the round wire coil 11 is pressed using a molding metal mold 51 to form a flat square wire coil 12. FIGS. 3 and 4 are schematic diagrams in the case of manufacturing the coil (flat square wire coil 12) with the molding metal mold 51 so that an outer shape of the coil after pressing is a substantially rectangular parallelepiped. FIGS. 3(A), 3(C), 4(A), and 4(C) are cross-sectional views corresponding to the cross section taken along line X-X in FIG. 2(B), and FIGS. 3(B), 3(D), 4(B), and 4(D) are plan views showing a molding region 550 of the round wire coil 11, this region being defined by the molding metal mold 51.

As shown in FIG. 3(A), the molding metal mold 51 includes a first metal mold 511 and a second metal mold 512 that can move relative to each other in one direction (e.g., up-down direction).

In this example, the first metal mold 511 is an upper metal mold, and the second metal mold 512 is a lower metal mold. The first metal mold (upper metal mold) 511 includes a base portion 510 and a recess portion 513 provided on the base portion 510 to allow part of the round wire coil 11 before molding (pressing) to be housed therein. In other words, the first metal mold 511 is a recess metal mold in this example. In this case, the overall shape of the recess portion 513 is a substantially rectangular parallelepiped, with an insertion hole 513B provided in the vicinity of the center thereof. The surface around the insertion hole 513B that faces an open portion OP of the recess portion 513 (bottom surface of the recess portion which is an upper surface in the drawing) serves as a pressing surface 513A for the round wire coil 11.

The second metal mold 512 (e.g., the lower metal mold) includes a base portion 514 and a shaft 515 that protrudes from the base portion 514 toward the first metal mold 511. The shaft 515, which is I-shaped in plan view, can be inserted into the inner circumferential side of the round wire coil 11 to support the round wire coil 11. In other words, the second metal mold 512 is a protruding metal mold in this example. A height H1 of the shaft 515 is larger than a height (thickness in the extending direction of the helical axis AX) H2 of the round wire coil 11.

As shown in FIG. 3(C), a length (width) W1 of the recess portion 513 in a transverse direction is slightly larger than a length (width) W2 of the shorter side SS of the round wire coil 11. As shown in FIG. 3(D), a length L1 of the recess portion 513 in a longitudinal direction is slightly larger than a length L2 of the longer side LS of the round wire coil 11.

With reference to FIG. 3(B), the molding region 550 in the present embodiment is defined by relative movement (moving closer to each other) of the first metal mold 511 and the second metal mold 512, that is, combination of the recess metal mold and the protruding metal mold. The molding metal mold 51 houses the round wire coil 11 in the molding region 550, and presses and deforms the round wire coil 11. In this example, since the first metal mold 511 is a substantially rectangular parallelepiped while the second metal mold 512 is I-shaped so as to be able to be housed in the first metal mold 511, the molding region 550 is in the shape of a rectangular frame having shorter side portions 551, longer side portions 552, and corner portions 553 in plan view. The corner portions 553 are also configured to be (substantially) right angled (so as not to form intentional curved portions).

When a length of the molding region 550 in the direction of crossing its winding direction (length of a strip transverse direction when the winding direction is a strip longitudinal direction) is defined as a “width of the molding region 550”, a width WL3 (length of diagonal) of the corner portion 553 is set larger than a width WL2 of the longer side portion 552. Furthermore, a width WL1 of the shorter side portion 551 is larger than the width WL2 of the longer side portion 552.

### Step of Forming Flat Square Wire Coil (Step S03)

Hereinafter, molding by the molding metal mold 51 will be described in chronological order with reference to FIGS. 3 and 4. First, as shown in FIG. 3(A), the round wire coil 11 is arranged on the second metal mold 512 so that the shaft 515 of the second metal mold 512 is inserted into the inner circumference of the round wire coil 11. Then, the first metal mold 511 and the second metal mold 512 are moved relative to each other so as to be in close proximity to each other as shown in FIG. 3(C). This movement allows the recess portion 513 to cover the outside of the round wire coil 11. The shaft 515 is inserted into the insertion hole 513B in the first metal mold 511. The round wire coil 11 is housed in the molding region 550 created by (the recess portion 513 of) the first metal mold 511 and (the shaft 515 of) the second metal mold 512 (FIG. 3(D)).

As shown in FIG. 4(A), when the first metal mold 511 and the second metal mold 512 are put in closer proximity to each other, the round wire coil 11 is housed in the molding region 550 and is also pressed in the extending direction of the helical axis AX by the pressing surface 513A and the base portion 514. Accordingly, the diameter of the round wire conductor M0 of the round wire coil 11 is compressed in the extending direction of the helical axis AX (helical axis direction A1) while the diameter of the round wire conductor M0 is expanded along the direction of a plane perpendicular to the helical axis AX (helical axis intersecting plane direction A2), so that the shape of the cross section that intersects (is orthogonal to) the extending direction (longitudinal direction, helical traveling direction) of the round wire conductor M0 (hereinafter simply referred to as the “cross sectional shape of a conductor”) becomes substantially elliptic (oval or square with rounded corners).

Next, as shown in FIG. 4(C), the first metal mold 511 and the second metal mold 512 are placed in close proximity to further press the round wire coil 11. The length (thickness) of the conductor M0 of the round wire coil 11 is further compressed along the helical axis direction A1, and the length of the conductor (length in the direction orthogonal to the helical traveling direction (width in the strip transverse direction)) is further expanded along the helical axis intersecting plane direction A2, while the inner circumferential corner portions RI of the one-turn region CR is molded into a substantially right angle in plan view as shown in FIG. 3(D). As a result, the flat square wire coil 12 as shown in FIG. 3(E) is formed. The flat square wire coil 12 in the present embodiment becomes a coil having a substantially rectangular one-turn region CR in plan view, since the cross-sectional shape of the conductor is substantially rectangular (see FIG. 3(C)) and at least the inner circumferential corner portions RI (indicated by dashed circles in FIGS. 3(D) and 3(E)) of the one-turn region CR are substantially at right angles.

In the present embodiment, although the object to be pressed is the round wire conductor M0 shown in FIGS. 2(A)-2(D), the molding region 550 is configured with the corner portions 553 at right angles as shown in FIG. 3(B). When the round wire conductor M0 is compressed in the helical axis direction A1, the metal material of the round wire conductor M0 also flows in the helical axis intersecting plane direction A2 and spreads along the shape of the molding region 550. As for the shape of the round wire coil 11, as shown in FIGS. 4(A)-4(E), the length of the round wire coil 11 in the direction orthogonal to the helical traveling direction (width in the strip transverse direction) is widened, and a curvature of the curved corner portions RR is increased, as a result of which the flat square wire coil 12 is molded to have at least the inner circumferential corner portions RI of the one-turn region CR being at substantially right angles in particular. The amount of pressing by the molding metal mold 51 is the amount sufficient enough for the metal material to spread to at least the corner portions 553 of the molding region 550.

Here, the molding region 550 by the molding metal mold 51 in the present embodiment is configured such that the width WL3 of the corner portions 553 (diagonal length) is set to be larger than the width WL2 of the longer side portions 552, and the width WL1 of the shorter side portions 551 is further set to be larger than the width WL2 of the longer side portions 552. The shorter side portion 551, including the corner portions 553 on both the ends thereof, is a region where a straight traveling length in the strip longitudinal direction is short, and when the pressed metal material locally stagnates, an unintentional thickened portion may be formed. In the present embodiment, since the width WL3 of the corner portions 553 and the width WL1 of the shorter side portions 551 are made larger than the width WL2 of the longer side portions, the flowing metal becomes easily spread over the entire one-turn regions CR, making it possible to avoid the generation of the thickened portion due to local stagnation of the metal.

Note that molding by the molding metal mold 51, that is, molding of the round wire coil 11 into the flat square wire coil 12, may be achieved by one pressing session or may be achieved by a plurality of pressing (stamping) sessions.

The flat square wire coil 12 becomes a substantially rectangular coil, in which the cross sectional shape of the conductor is substantially rectangular as shown in FIG. 4(C) and also at least the inner circumferential corner portions RI are at substantially right angles in plan view as shown in FIGS. 4(D) and 4(E).

### Annealing Step (Step S05)

Afterwords, the flat square wire coil 12 is annealed and deformed into a desired shape as necessary. This deformation is, for example, a deformation for a later coating step, to separate each turn of the flat square wire coil 12 to such an extent that each turn can be coated. It is also possible to deform the lead-out portion TO to allow connection with a desired terminal, for example. The annealing step does not have to be performed. Furthermore, when molding by a metal mold causes burrs (unintended protruding sections, etc.) on, for example, a side surface of the flat square wire coil 12, a deburring step may be performed before or after the annealing step.

### Coating Step (Step S07)

Next, the surface of the conductor of the flat square wire coil 12 is coated with an insulating resin (cover with insulating film). Coating with the insulating resin is performed by electrodeposition coating, for example. Each turn of the helix of the flat square wire coil 12 is separated by, for example, molding after annealing, this separation allowing sufficient contact with the paint solution throughout the entire helical structure. Hence, the conductor portions corresponding to the respective helical turns are insulated from each other. Here, coating with an insulating resin may be performed by spraying insulating resin materials or injection molding of an insulating resin.

After the coating with an insulating resin, appropriate molding of the flat square wire coil 12 (for example, compression to reduce the distance between the one-turn regions CR, or molding for the outer shape of the coil) is performed as appropriate to complete the flat square wire coil 12. According to the present embodiment, it is possible

to easily form a high-precision flat square wire coil 12 that is rectangular in plan view by winding the round wire conductor M0 in a helical form and pressing the round wire conductor M0 in the helical axis direction A1 with the molding metal mold 51.

The flat square wire coil 12 is a coil formed by winding a long-length conductor in a helical form and is configured to have an outer shape of a substantially rectangular parallelepiped, the conductor having a substantially rectangular cross section. The flat square wire coil 12 is also a coil having a substantially rectangular one-turn region CR that has at least the inner circumferential corner portions RI formed at substantially right angles in plan view as viewed from the helical axis direction.

The flat square wire coil 12 having the inner circumferential corner portions RI at substantially right angles can improve the space factor when the flat square wire coil 12 is mounted on a stator and therefore contributes to higher performance of the motor. In short, according to the present embodiment, the flat square wire coil 12 suitable as a motor component does not require complicated steps and apparatuses and can be manufactured by simple apparatuses and steps, making it possible to reduce manufacturing costs and to improve productivity (mass production speed).

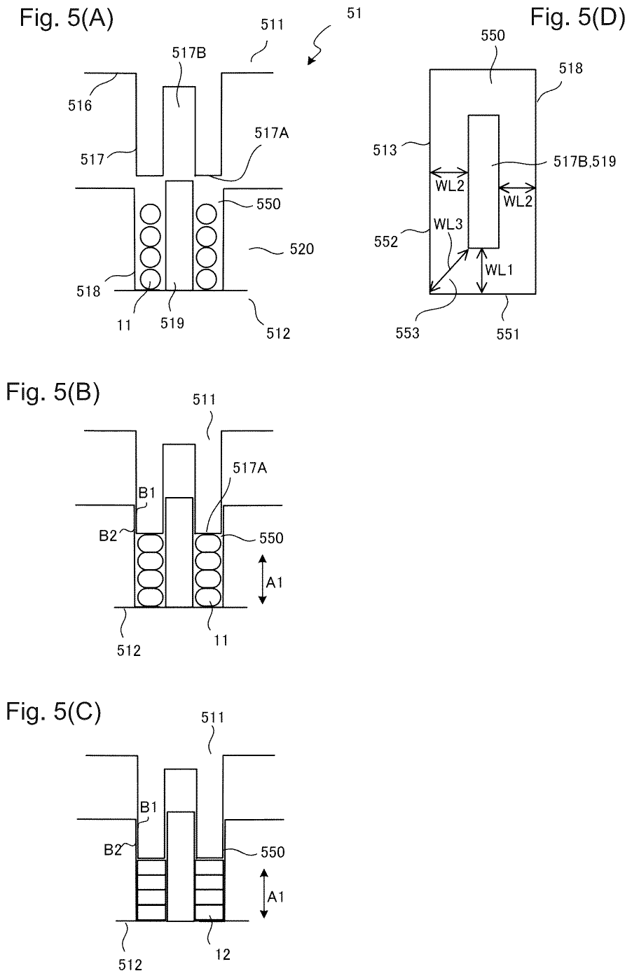

Other examples of the molding metal mold 51 will be described with reference to FIGS. 5 to 7. FIGS. 5 to 7 are diagrams showing an example of manufacturing the flat square wire coil 12 using another molding metal mold 51, in which FIGS. 5(A), 6(A), and 7(A) are cross-sectional views corresponding to FIG. 3(A), FIGS. 5(B), 6(B), and 7(B) are cross-sectional views corresponding to FIG. 4(A), and FIGS. 5(C), 6(C), and 7(C) are cross-sectional views corresponding to FIG. 4(C). FIG. 5(D) is also a plan view of the molding region 550 corresponding to FIG. 3(B).

FIGS. 5(A)-5(D) show an example in which the outer shape of the flat square wire coil 12 to be manufactured is a substantially rectangular parallelepiped, with a first metal mold (upper metal mold) 511 of the molding metal mold 51 being a protruding metal mold and a second metal mold (lower metal mold) 512 being a recess metal mold. As shown in FIG. 5(A), the first metal mold 511 (upper metal mold) of the molding metal mold 51 includes a base portion 516 and a pressing portion 517 that protrudes from the base portion 516 toward the second metal mold 512. The outer shape of the pressing portion 517 is a rectangular parallelepiped. Furthermore, the pressing portion 517 includes an insertion hole 517B of an I shape in plan view in the vicinity of the center thereof (see FIG. 5(D)) and is a rectangular frame-shaped protrusion in plan view. The pressing portion 517 includes a pressing surface 517A on the surface facing the second metal mold 512.

The second metal mold (lower metal mold) 512 includes a recess portion 518 in a substantially rectangular parallelepiped shape provided on the base portion 520 and a shaft 519 protruding in the vicinity of the center thereof. The shaft 519 is I-shape in plan view in the same way as the shaft 515 shown in FIGS. 3(A)-3(D) (FIG. 5(D)). Part of the pressing portion 517 can be housed in the recess portion 518, and the shaft 519 can be inserted into the insertion hole 517B.

In this case, as shown in FIG. 5(A), the round wire coil 11 formed with the round wire conductor M0 is housed in the recess portion 518 of the second metal mold 512 and is pressed (compressed) in the helical axis direction A1 by the pressing portion 517 of the first metal mold 511 (FIG. 5(B)). In this case, the molding region 550 of the round wire coil 11 is defined by the pressing portion 517 of the first metal mold 511, the recess portion 518 of the second metal mold 512 and the recess portion 513, and the shape of the molding region 550 in plan view is a rectangular frame shape having the shorter side portions 551, the corner portions 553, and the longer side portions 552 as shown in FIG. 5(D). In short, the shape of the molding region 550 is similar to the molding region 550 shown in FIG. 3(B). The round wire coil 11 is pressed while being housed in the molding region 550 and is molded into the flat square wire coil 12 as shown in FIG. 5(C). An appearance shape of the flat square wire coil 12 is the same as that shown in FIG. 4(E).

Specifically, the flat square wire coil 12 in this case is also a coil formed by winding a long-length conductor in the helical form and configured to have an outer shape of a substantially rectangular parallelepiped, the conductor having a substantially rectangular cross section. The flat square wire coil 12 is also a coil having a substantially rectangular one-turn region CR that has at least the inner circumferential corner portions RI formed at substantially right angles in plan view as viewed from the helical axis direction.

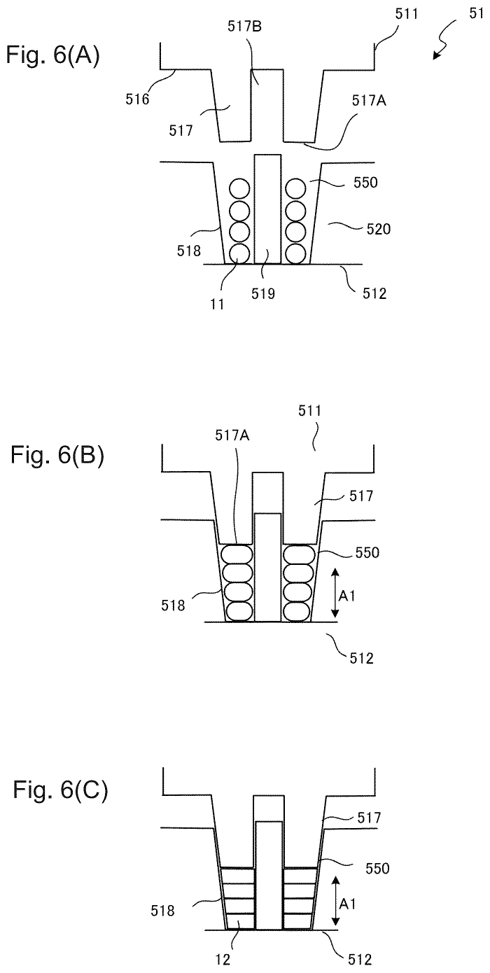

FIGS. 6(A)-6(C) show an example of the molding metal mold 51 in which the outer shape of a finished coil (flat square wire coil 12) is a substantially truncated square pyramid. The molding metal mold 51 in this example is similar in configuration to the metal mold shown in FIGS. 5(A)-5(D) except that the outer shape of the finished coil (flat square wire coil 12) is a truncated square pyramid. Specifically, as shown in FIG. 6(A), the first metal mold 511 (upper metal mold) of the molding metal mold 51 includes the base portion 516 and the pressing portion 517 that protrudes from the base portion 516. The pressing portion 517 has an outer shape of a truncated square pyramid and includes the insertion hole 517B of an I shape in plan view in the vicinity of the center thereof. In plan view, the pressing portion 517 is a rectangular frame-shaped protrusion. A distal end surface of the pressing portion 517 faces the second metal mold 512, and this surface constitutes the pressing surface 517A. The second metal mold (lower metal mold) 512 includes the recess portion 518 and the shaft 519 of an I shape in plan view, the shaft 519 protruding in the vicinity of the center of the recess portion 518. The recess portion 518 is in a truncated square pyramid shape. Part of the pressing portion 517 can be housed in the recess portion 518, and the shaft 519 can be inserted into the insertion hole 517B.

The molding region 550 of the round wire coil 11 is defined by the pressing portion 517 of the first metal mold 511 and the recess portion 518 of the second metal mold 512, and the shape of the molding region 550 in plan view is a rectangular frame shape having the shorter side portions 551, the corner portions 553, and the longer side portions 552 as in the case of FIG. 5(D).

In this case, as shown in FIG. 6(A), the round wire coil 11 formed with the round wire conductor M0 is housed in the recess portion 518 of the second metal mold 512 and is pressed (compressed) in the helical axis direction A1 by the pressing portion 517 (pressing surface 517A) of the first metal mold 511 (FIG. 6(B)). As a result, the flat square wire coil 12 is molded as shown in FIG. 6(C).

The appearance of the flat square wire coil 12 is the same as that shown in FIG. 4(E) except that the outer shape is a substantially truncated square pyramid. In short, the flat square wire coil 12 is a coil formed by winding a long-length conductor in a helical shape and configured to have an outer shape of a substantially truncated square pyramid, the conductor having a substantially rectangular cross section. The flat square wire coil 12 is also a coil having a substantially rectangular one-turn region CR that has at least the inner circumferential corner portions RI formed at substantially right angles in plan view as viewed from the helical axis direction.

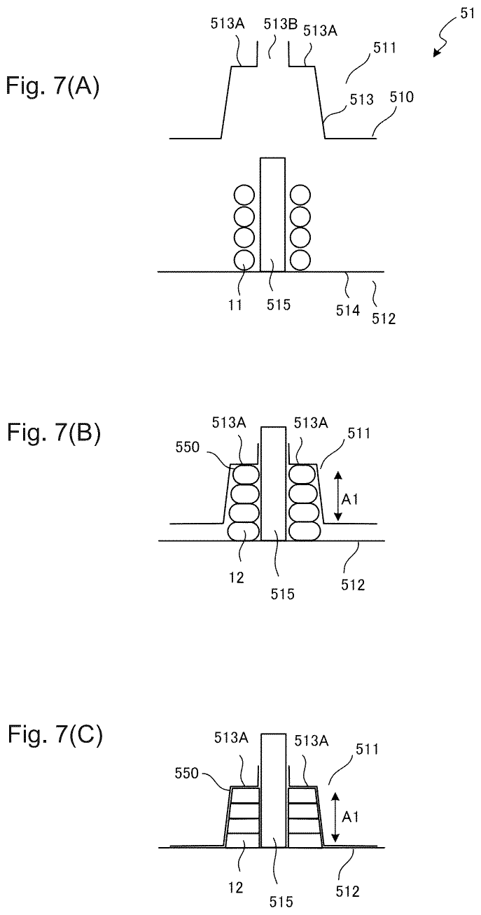

FIGS. 7(A)-7(C) show another example of the molding metal mold 51 in which the outer shape of the finished coil (flat square wire coil 12) is a substantially truncated square pyramid. The molding metal mold 51 in this example is similar in configuration to the metal mold shown in FIGS. 3 and 4 except that the outer shape of the finished coil (flat square wire coil 12) is a truncated square pyramid. Specifically, the first metal mold (upper metal mold) 511 of the molding metal mold 51 includes the base portion 510, the recess portion 513 provided on the base portion 510 and capable of housing part of the round wire coil 11 before molding (pressing), and the insertion hole 513B of an I shape in plan view in the vicinity of the center thereof. The second metal mold 512 (e.g., the lower metal mold) includes the base portion 514 and the shaft 515 of an I shape in plan view, the shaft 515 protruding from the base portion 514 toward the first metal mold 511. In the molding metal mold 51, the molding region 550 defined by (the recess portion 513 of) the first metal mold 511 and (the shaft 515 of) the second metal mold 512 has a rectangular frame shape as in FIG. 3(D).

In this case, as shown in FIG. 7(A), the round wire coil 11 formed with the round wire conductor M0 is housed in the recess portion 513 of the first metal mold 511 and is pressed (compressed) in the helical axis direction A1 by the pressing surface 513A of the recess portion 513 and the base portion 514 (FIG. 7(B)). As a result, the flat square wire coil 12 is molded as shown in FIG. 7(C).

The appearance of the flat square wire coil 12 in this example is the same as that shown in FIG. 4(E) except that the outer shape is a substantially truncated square pyramid. In short, the flat square wire coil 12 is a coil formed by winding a long-length conductor in a helical shape and configured to have an outer shape of a substantially truncated square pyramid, the conductor having a substantially rectangular cross section. The flat square wire coil 12 is also a coil having a substantially rectangular one-turn region CR that has at least the inner circumferential corner portions RI formed at substantially right angles in plan view as viewed from the helical axis direction.

Here, for example, the molding metal mold 51 shown in FIGS. 5(A)-5(D) has a configuration in which an outer side surface of the upper metal mold 511 enters into an inner side surface of the lower metal mold 512 as pressing progresses. As shown in FIGS. 5(B) and 5(C), as the side surfaces B1 and B2 of both the metal molds face each other in close proximity, a slight gap is formed and the side surfaces B1 and B2 move relative to each other during the pressing. In such a configuration, depending on the pressing conditions and materials of the conductor (particularly in the case of materials that are easily deformed), part of the conductor that fluidly deforms may enter (be caught) in the gap because of the pressing and may thus cause formation of an unintended thickened portion on the outer circumference of the coil or formation of burrs-like protrusions extending toward the upper metal mold. In this case, it is desirable to remove the thickened portion or burr-like protrusions after molding of the second-shape flat square wire coil 12 and/or the flat square wire coil 12 as necessary (before the coating step).

In contrast, in the case of the molds configured as shown in FIGS. 3, 4, and 7, there are no side surfaces that face each other in close proximity and move relative to each other on the first metal mold 511 and the second metal mold 512 (component members corresponding to the side surfaces B1 and B2 in FIGS. 5(A) and 5(C)). In other words, at least at side surface portions of the object to be molded (round wire coil 11, flat square wire coil 12), the gap that allows intrusion of the conductor is not generated between the first metal mold 511 and the second metal mold 512. As a result, the formation of an unintended thickened portion or burr-like protrusions on the outer circumference of the coil is prevented.

The round wire conductor M0 in the present embodiment has been illustrated by taking as an example the case where the round wire conductor M0 is a metal wire mainly made of aluminum. However, without being limited thereto, the round wire conductor M0 may be a metal wire mainly made of copper, or a metal wire mainly made of other metals. The metal wire “mainly made of (a certain) metal” refers to a metal wire constituted of the relevant metal or alloys of the relevant metal such as, for example, a linear metal material containing the relevant metal or alloys of the relevant metal at 50% or more. The round wire conductor M0 may also be a composite

material of a plurality of different metals. For example, the round wire conductor M0 may be made of a first metal (e.g., copper) and a second metal that is different from the first metal (e.g., aluminum) that are connected in the longitudinal direction of the round wire conductor M0. In this case, the type of the metal material of the round wire conductor M0 changes in the longitudinal direction. In other words, the round wire coil 11 formed by winding the round wire conductor M0 and the flat square wire coil 12 formed by molding the round wire coil 11 are coils in which the type of the metal material changes in the helical traveling direction (in the middle of winding). Such a configuration makes it possible to manufacture the flat square wire coil 12 in which, for example, a helical turn (one or more one-turn regions CR) that is closer to a rotor is constituted of aluminum while other turns are constituted of copper when the flat square wire coil 12 is attached to a stator.

Further in this case, the connection between two or more metal materials is preferably achieved by welding such as pressing (e.g., cold pressure welding) between respective end faces in the longitudinal direction.

In the above-described embodiment, an example has been shown in which the round wire coil 11 is wound to have an outer shape of a substantially rectangular parallelepiped, though the round wire coil 11 may be wound to have an outer shape of a truncated square pyramid.

### Second Embodiment

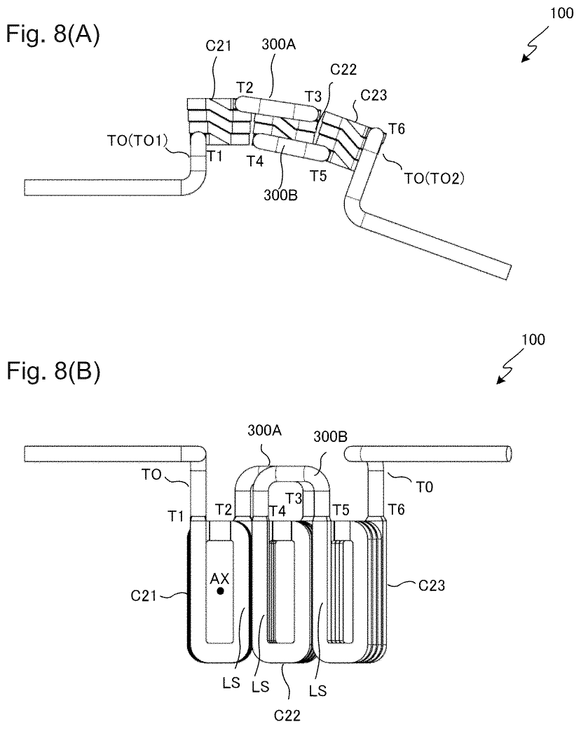

A second embodiment of the present invention will be described with reference to FIGS. 8 to 14. The second embodiment relates to a manufacturing method of a coil unit 100 formed by coupling a plurality of coils C2, and the manufacturing method of a coil of the first embodiment can be applied thereto.

FIGS. 8(A) and 8(B) include appearance views showing an example of the coil unit 100 in the second embodiment, in which FIG. 8(A) is a top view, and FIG. 8(B) is a front view of a certain coil C2 (C21) that constitutes the coil unit 100 as viewed from the direction of the helical axis AX.

As shown in FIGS. 8(A) and 8(B), the coil unit 100 in the second embodiment is constituted of the plurality of (three in this case) coils C2 coupled through a coupling portion 300. The three coils C2 (C21 to C23) are, for example, concentrated winding coils with a helical structure, which are flat square wire coils each having substantially rectangular one-turn regions CR in front view as viewed from the direction of the helical axis AX. In the coil unit 100, the respective coils C2 are arranged side by side so that their longer sides LS are adjacent (proximate) to each other and are coupled to each other through the coupling portion 300 (300A, 300B) at positions where they do not overlap with the winding regions of the respective coils C2 (above the helices (winding regions) of the respective coils C2 in this example). Specifically, one end portion T1 of the winding of the first coil (the coil C21 arranged on the left in FIGS. 8(A) and 8(B)) serves as a lead-out portion TO (TO1), and the other end portion T2 is coupled to one end portion T3 of the second coil (the coil C22 arranged in the middle in FIGS. 8(A) and 8(B)) through one coupling portion 300A. The other end portion T4 of the second coil C22 is coupled to one end portion T5 of the third coil (the coil arranged on the right in FIGS. 8(A) and 8(B)) through the other coupling portion 300B, and the other end portion T6 of the third coil C23 serves as the other lead-out portion TO (TO2).

In the coil unit 100, the three coils C2 are integrally covered with an insulating resin. In the coil unit 100, the helix of each coil C2 is unfolded to be one conductor, and the insulating resin covers the surface of the one conductor. In other words, in winding region portions of the respective coils C2, the respective one-turn regions CR are insulated from other one-turn regions CR by the insulating resin.

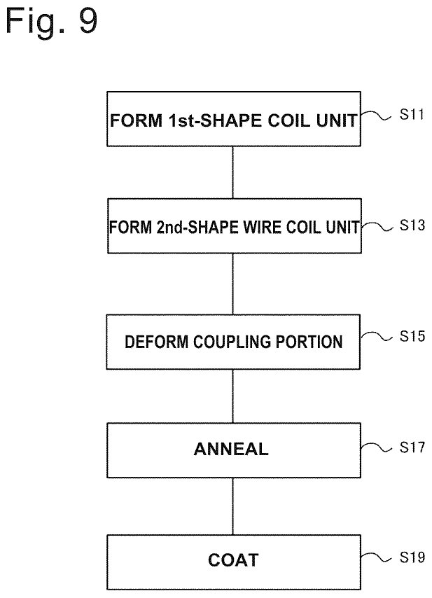

FIG. 9 is a flowchart showing an example of the manufacturing method of the coil unit 100 of the second embodiment. The manufacturing method of the coil unit 100 includes a step of winding a conductor to form the first-shape coil unit 101 including the coupling portion 300 and the plurality of first-shape coils C1 to be coupled through the coupling portion 300 (step S11), a step of pressing the first-shape coil unit 101 by a molding metal mold to form the second-shape coil unit 102 including the plurality of second-shape coils C2 continuously joined (step S13), a step of deforming the coupling portion 300 (step S15), a step of annealing the second-shape coil unit 102 (step S17), and a step of coating the second-shape coil unit 102 with a resin material (step S19).

Here, the first-shape coil C1 and the second-shape coil C2 in the second embodiment are both the coils that are formed by winding a conductor and that are different in cross-sectional shape and/or size (cross-sectional area) of the conductor that intersects (that is orthogonal to) a winding travel direction (conductor extending direction, longitudinal direction).

Specifically, for example, the first-shape coil C1 is a coil configured by winding a long-length conductor (round wire conductor M0) having a substantially circular shape in cross section in a helical form, with an outer shape being configured into a substantially rectangular parallelepiped (or a substantially truncated square pyramid). In short, as one example, the first-shape coil C1 is the round wire coil 11 shown in FIGS. 2(A)-2(D). Note that the conductor (round wire conductor M0) in the second embodiment is similar to the conductor described in the first embodiment.

The second-shape coil C2 is a coil having a configuration obtained by winding, for example, a long-length conductor in a helical form, the conductor having a non-circular shape in cross section, and the outer shape of the coil being configured into a substantially truncated square pyramid (or a rectangular parallelepiped). The conductor of the second-shape coil C2 has a substantially rectangular shape in cross section in one example. The second-shape coil is also a coil having a substantially rectangular one-turn region CR that has at least the inner circumferential corner portions RI formed at substantially right angles in plan view as viewed from the helical axis direction. In short, as one example, the second-shape coil is the flat square wire coil 12 as shown in FIGS. 4(E) and 7.

In the following description, a case where the first-shape coil C1 is the round wire coil 11 (see FIGS. 2(A)-2(D)), and the second-shape coil C2 is the flat square wire coil 12 having an outer shape of a substantially truncated square pyramid (FIGS. 7 and 8) will be described as one example. Hereinafter, a description will be mainly given of the portions different from those in the first embodiment, and particulars not specifically mentioned are deemed to be the same as those in the first embodiment and a description thereof will be omitted.

Specifically, the coil unit 100 shown in FIGS. 8(A) and 8(B) in a completed state, which is formed by continuously joining the plurality of (three in this example) flat square wire coils 12 in the first embodiment via the coupling portion 300, is formed from a single round wire conductor M0 as shown in FIGS. 2(A)-2(D). Hereinafter, an example of the manufacturing method of a coil unit according to the second embodiment of the present invention will be described.

### Step of Forming First-Shape Coil (Round Wire Coil) Unit (Step S11)

First, a round wire conductor M0 is wound to form the first-shape coil unit (round wire coil unit) 101 constituted of the coupling portion 300 and the plurality of round wire coils 11 to be coupled through the coupling portion 300.

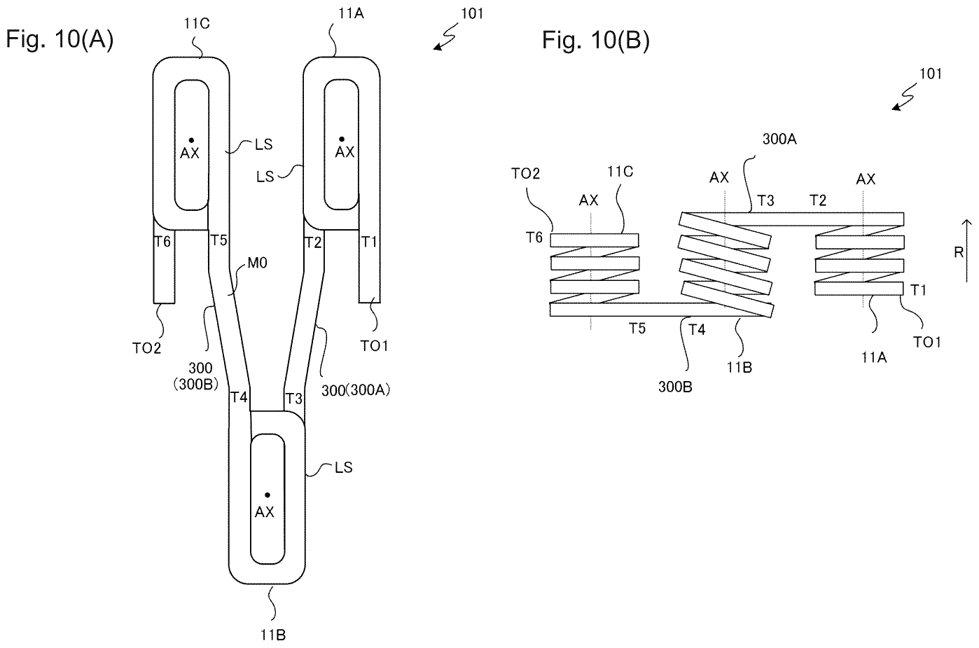

FIGS. 10(A) and 10(B) include appearance views of the round wire coil unit 101, in which FIG. 10(A) is a view (plan view) of the round wire coil unit 101 as viewed from the direction of the helical axis AX, and FIG. 10(B) is a schematic view (top view) of the round wire coil unit 101 of FIG. 10(A) as viewed from above.

The round wire coil unit 101 has a configuration in which three round wire coils 11A to 11C are coupled through the coupling portion 300 in this example. Hereinafter, when it is necessary to distinguish between the three round wire coils 11A to 11C, they are referred to as a first round wire coil 11A, a second round wire coil 11B, and a third round wire coil 11C for the convenience of description.

The material (wire material) of the round wire coil unit 101 is the round wire conductor M0 as in the case of the first embodiment (FIG. 2(A)). More specifically, the round wire conductor M0 is wound with a desired number of turns to form the first round wire coil 11A. An end portion T1 of the first round wire coil 11A serves as a lead-out portion TO1. Then, a prescribed length of the other end portion T2 of the first round wire coil 11A is secured in a non-winding state, and the second round wire coil 11B is wound continuously to the other end portion T2. An end portion T3 of the second round wire coil 11B is continuous to the end portion T2 of the first round wire coil 11A, and the round wire conductor M0 in the non-winding state between the end portions T2 and T3 serves as the coupling portion 300 (300A). Similarly, a prescribed length of the other end portion T4 of the second round wire coil 11B is secured in a non-winding state, and the third round wire coil 11C is wound continuously to the other end portion T4. An end portion T5 of the third round wire coil 11C is continuous to the end portion T4 of the second round wire coil 11B, and the round wire conductor M0 in the non-winding state between the end portions T4 and T5 serves as the coupling portion 300. The other end portion T6 of the third round wire coil 11C serves as the other lead-out portion TO2.

In this example, the three round wire coils 11A to 11C are arranged in a triangular shape (substantially Y shape) as shown in FIG. 10(A) as an initial arrangement (before pressing by the metal mold) in plan view, and are coupled to each other through the coupling portion 300. However, the initial arrangement is not limited to this example as long as the respective round wire coils 11 are coupled through the coupling portion 300 of a prescribed length. For example, it is possible to adopt a configuration where the three round wire coils 11A to 11C are connected to each other via the coupling portion 300 and arranged side by side so that the respective longer sides LS are parallel to each other.

In this example, as shown in FIG. 10(B), the helical winding direction (turning direction) of the three round wire coils 11A, 11B, and 11C are identical to one another, for example, all the three round wire coils 11A, 11B, and 11C are wound counterclockwise (left-handed helix) when the helical axis AX is viewed from the R-direction. All the three round wire coils 11A, 11B and 11C may be wound clockwise (right-handed helix).

In this way, the round wire coil unit 101, which is constituted of the plurality of (three in this case) round wire coils 11A to 11C that are coupled through the coupling portion 300, is formed. The lead-out portions TO1 and TO2 and the coupling portion 300 are all located outside the helical winding regions of the round wire coils 11A to 11C.

### Step of Forming Second-Shape Coil Unit (Flat Square Wire Coil Unit) (Step S13)

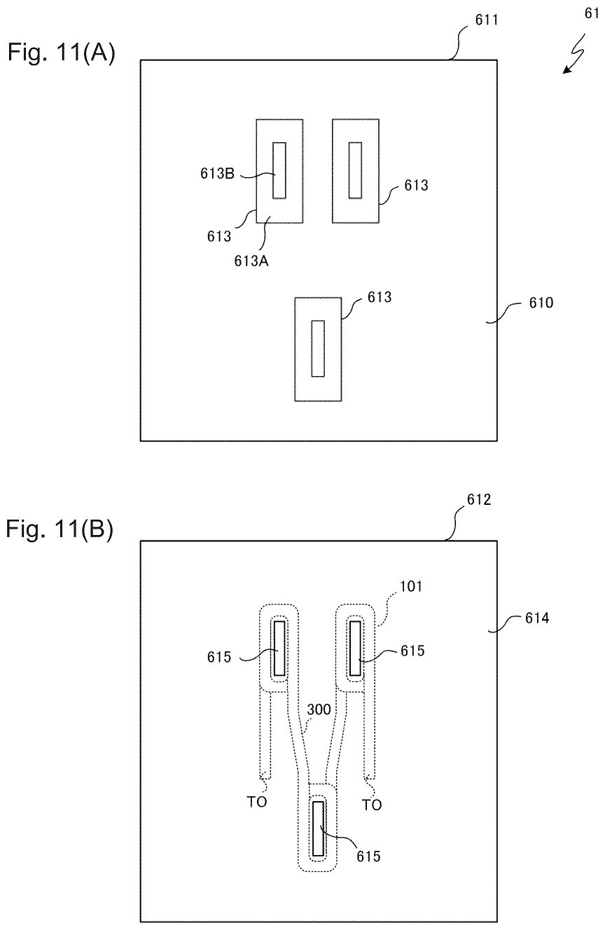

Next, the round wire coil unit 101 is pressed using the molding metal mold 61 to form the second-shape coil unit (flat square wire coil) 102. FIGS. 11(A) and 11(B) include schematic drawings showing an example of the molding metal mold 61, in which FIG. 11(A) is a plan view of a first metal mold 611, and

FIG. 11(B) is a plan view of a second metal mold 612. The molding metal mold 61 includes the first metal mold 611 and the second metal mold 612 that can move relative to each other in one direction (e.g., up-down direction) to press part of the round wire coil unit 101 when the first metal mold 611 is in close proximity to the second metal mold 612.

In one example, the molding metal mold 61 is similar in configuration to the first embodiment except that there are the plurality of (three in this case) round wire coils 11 that can be pressed by one pair (one unit) of the first metal mold 611 and the second metal mold 612, that is, the round wire coil unit 101 can be pressed integrally. In other words, the first metal mold (e.g., the upper metal mold) 611 has three recess portions 613 formed on a single base portion 610. The three recess portions 613 are identical in configuration (shape) and are all similar to the recess portion 513 in the first embodiment shown in FIG. 3, 4 or 7 including cross-sectional views, for example. Specifically, the recess portions 613 each have an insertion hole 613B provided in the vicinity of the center, and the bottom surface of each of the recess portions 613 around the insertion hole 613B serves as a pressing surface 613A. The second metal mold 612 (e.g., the lower metal mold) includes a base portion 614 and a shaft 615 that protrudes from the base portion 614 toward the first metal mold 611. The three shafts 615 are identical in configuration (shape) and are all similar to the shaft 515 in the first embodiment shown in FIG. 3, 4 or 7 including cross-sectional views, for example. Here, as one example, the outer shape of the second shape coil C2 (flat square wire coil 12) is a substantially truncated square pyramid as shown in FIGS. 8(A) and 8(B), and the configuration of the molding metal mold 61 is the same as that in FIGS. 7(A)-7(C). Note that the molding metal mold 61 may have the configuration of the first embodiment as shown in FIGS. 5(A)-5(D) or FIGS. 6(A)-6(C).

Hereinafter, molding by the molding metal mold 61 is described in chronological order. Since the cross-sectional shape of each of the round wire coils 11A to 11C at the time of pressing is the same as that in the first embodiment, the drawings such as FIGS. 3, 4, and 7 are referenced. As shown in FIG. 11(B), the three shafts 615 of the second metal mold 612 are inserted into the round wire coils 11A to 11C, respectively. Then, the first metal mold 611 and the second metal mold 612 are moved relative to each other so as to be in close proximity to each other (see FIG. 7(A). The three recess portions 613 of the first metal mold 611 cover the outside of the corresponding round wire coils 11A to 11C. The shafts 615 of the second metal mold 612 are inserted into the insertion hole 613B provided on the first metal mold 611 (see FIG. 3(C)). When the first metal mold 611 and the second metal mold 612 are put in closer proximity to each other, the round wire coils 11A to 11C are housed in molding regions (similar to the molding region 550 shown in FIGS. 3(B)-3(C)) defined by the pressing surfaces 613A of the first metal mold 611, and the base portion 614 and the shafts 615 of the second metal mold 612, and are also pressed in the helical axis direction A1 by the pressing surfaces 613A and the base portion 614 (see FIG. 7(B)).

Accordingly, in the round wire coils 11A to 11C, the diameter of the round wire conductor M0 is compressed along the helical axis direction A1 while the diameter of the round wire conductor M0 is expanded along the direction of the helical axis intersecting plane direction A2, which results in formation of the flat square wire coils 12A to 12C. The flat square wire coils 12A to 12C in the present embodiment are coils each having a substantially rectangular one-turn region CR in plan view, since the cross-sectional shape of the conductor is substantially rectangular as well as at least the inner circumferential corner portions RI of the one-turn region CR are substantially at right angles (see FIGS. 7(C) and 4(E)).

Although detailed illustrations are omitted in FIGS. 11(A) and 11(B), as an example, the lead-out portion TO of the round wire coil unit 101 and the coupling portion 300 are configured so as not to be affected (crushed) by pressing force due to the presence of, for example, a spacer (and/or a cover). Specifically, in the round coil unit 101, only a substantial helical structure portion of the plurality of round wire coils 11A to 11C is pressed, and in the coupling portion 300, an original shape of the round wire conductor M0 is maintained.

In this way, the plurality of flat square wire coils 12A to 12C are coupled through the coupling portion 300 of the round wire conductor M0, and thereby the flat square wire coil unit 102 is formed.

### Step of deforming coupling portion (Step S15)

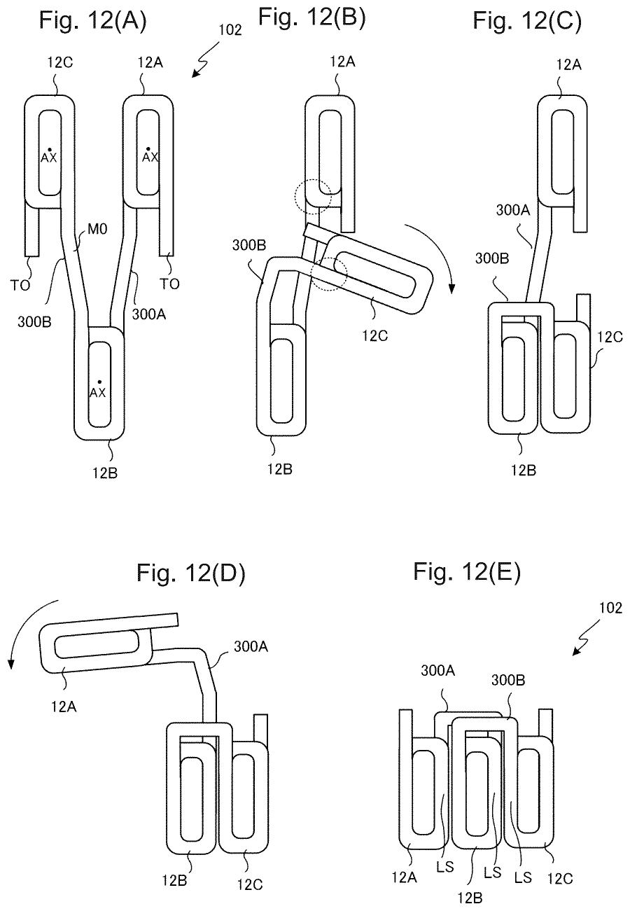

Next, the step of deforming the coupling portion 300 will be described with reference to FIGS. 12(A)-12(E). FIGS. 12(A)-12(E) include plan views of the flat square wire coil unit 102 as viewed from the helical axis AX direction. In the square wire coil unit 102, three square wire coils 12A to 12C are coupled through the coupling portion 300 (300A, 300B) of the round wire conductor M0. Hereinafter, when the three flat square wire coils 12A to 12C are distinguished from each other, they are referred to as a first flat square wire coil 12A, a second flat square wire coil 12B, and a third flat square wire coil 12C for the convenience of description.

In this step, at least one coil, out of the plurality of flat square wire coils 12A to 12C, is deformed so as to move relatively to other coils. Specifically, the coupling portion 300 is deformed so that at least one coil is moved to a position adjacent (proximate) to the other coils. The deformation of the coupling portion 300 is, for example, bending deformation and/or twisting deformation, and may include elongation.

Specifically in this example, as shown in FIG. 12(A), the coupling portion 300 (300A and 300B) has a prescribed length, and three flat square wire coils 12A to 12C are arranged at substantially Y-shaped positions so as to be separated from each other. In this step, the coupling portion 300 is deformed (for example, bent in a predetermined direction) to move the three separated flat square wire coils 12A to 12C to such positions that the respective longer sides LS are adjacent or proximate (side by side) to each other. Note that the flat square wire coils 12A to 12C are only pressed in the direction of the helical axis AX, and their winding direction (helical traveling direction) remains unchanged from the state shown in FIG. 10(B) in this example. FIG. 12(A) shows the state of the three flat square wire coils 12A to 12C molded by, for example, the molding metal mold 61 shown in FIGS. 11(A) and 11(B), and the three flat square wire coils 12A to 12C are arranged roughly in the same horizontal plane. More precisely, at least an uppermost or lowermost (outermost or innermost) one-turn region CR of each of the flat square wire coils 12A to 12C is arranged on a substantially identical plane.

Then, for example, as shown in FIG. 12(B), the coupling portion 300B is bent so that the third flat square wire coil 12C is rotated around the second flat square wire coil 12B and is thereby adjacent to the right side of the second flat square wire coil 12B while the extending direction of the helical axis AX is maintained (FIG. 12(C)). Since the three flat square wire coils 12A to 12C are arranged roughly in the same horizontal plane, part (such as the vicinity of broken line circles) of the third flat square wire coil 12C and the first flat square wire coil 12A may interfere with each other during deformation shown in FIG. 12(B), for example. In such a case, while the third flat square wire coil 12C is moved so as to rotate around the second flat square wire coil 12B, twisting deformation is also applied so as to move the third flat square wire coil 12C in the direction of the helical axis AX.

Then, as shown in FIG. 12(D), the coupling portion 300A is deformed so that the first flat square wire coil 12A is rotated around the second flat square wire coil 12B and is thereby adjacent to the left side of the second flat square wire coil 12B while the extending direction of the helical axis AX is maintained (FIG. 12(E)). Note that the order of deformation of the coupling portion 300 is not limited to the above-mentioned example. For example, the position of the first flat square wire coil 12A may be moved by deforming the coupling portion 300A and then the coupling portion 300B may be deformed to move the position of the third flat square wire coil 12C.

This makes it possible to obtain the flat square wire coil unit 102 with the three flat square wire coils 12A to 12C being side by side so that the respective longer sides LS are adjacent to each other.

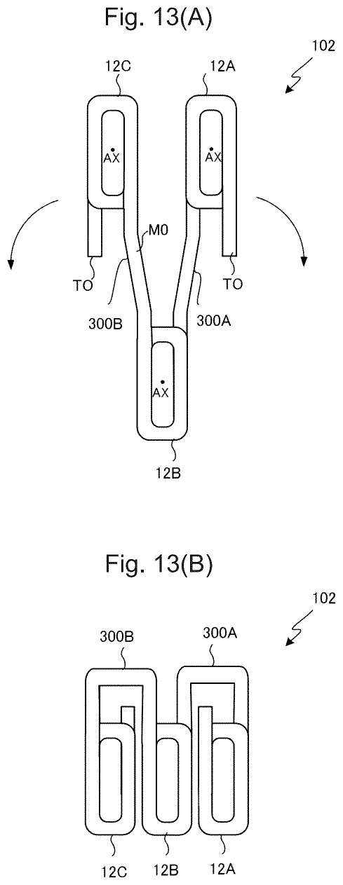

FIGS. 13(A) and 13(B) show another example of deforming the coupling portion 300 from the state shown in FIG. 12(A). As shown in FIGS. 13(A) and 13(B), the flat square wire coil unit 102, with the three flat square wire coils 12A to 12C being adjacent to each other side by side as shown in FIG. 13(B), may be formed by deforming (bending) the coupling portion 300A so that the first flat square wire coil 12A is adjacent to the right side of the second flat square wire coil 12B while maintaining the extending direction of the helical axis AX, and deforming (bending) the coupling portion 300B so that the third flat square wire coil 12C is adjacent to the left side of the second flat square wire coil 12B while maintaining the extending direction of the helical axis AX.

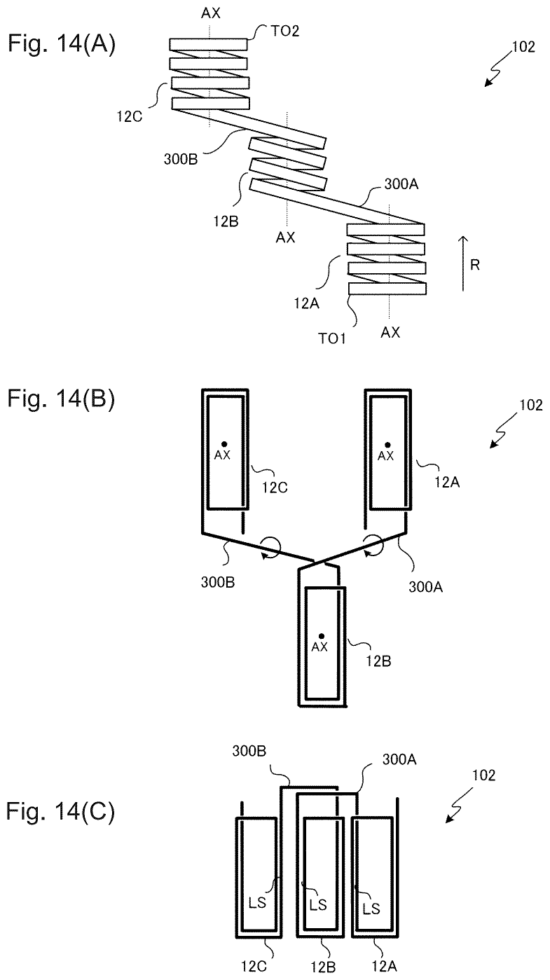

FIGS. 14(A)-14(C) include schematic diagrams showing the coupling state of the flat square wire coils 12A to 12C (round wire coils 11A to 11C) and another example of the deformation of the coupling portion 300. FIG. 14(A) is a top view of the flat square wire coil unit 102 corresponding to FIG. 10(B), and FIGS. 14(B) and 14(C) are schematic plan views of the flat square wire coil unit 102 as viewed from the helical axis direction.

In the example shown in FIG. 14(A), when the helical axis AX is viewed from R direction, the three flat square wire coils 12A to 12C coupled through the coupling portion 300 are different in helical winding direction (turning direction) from each other, that is, their winding directions change so as to be opposite to each other. For example, the first flat square wire coil 12A is wound clockwise (right-handed helix), the second flat square wire coil 12B is wound counterclockwise (left-handed helix), and the third flat square wire coil 12C is wound clockwise (right-handed helix). They may be would in the directions opposite to the directions described above. These coils are wound in such a way at the stage of forming the round wire coil unit 101.

In this case, for example, while the coupling portion 300A (round wire conductor M0) is twisted so as to rotate around the axis of the coupling portion 300A as indicated by an arrow in FIG. 14(B), the first flat square wire coil 12A is moved to the position that is on the right side of the second flat square wire coil 12B. Moreover, while the coupling portion 300B (round wire conductor M0) is twisted so as to rotate around the axis of the coupling portion 300B, the third flat square wire coil 12C is moved to the position that is on the left side of the second flat square wire coil 12B.

This makes it possible to form the flat square wire coil unit 102 with the three flat square wire coils 12A to 12C being side by side so that the respective longer sides LS are adjacent to each other as shown in FIG. 14(C).

Note that the winding method (winding direction) of the three flat square wire coils 12A to 12C and/or the method of deforming the coupling portion 300 are merely examples, and other winding methods and other deformation may be adopted without being limited to those illustrated above.

The positional relationship among the three flat square wire coils 12A to 12C after deformation of the coupling portion 300 is not limited to side-by-side arrangement as shown in FIGS. 12(E), 13(B), 14(C), and the like. The distance between the flat square wire coils 12A to 12C may be more spaced than the illustrated distance, and instead of the side-by-side arrangement, any arrangement may be selected, such as an arrangement in which the longer sides LS of one flat square wire coil 12 may be inclined with respect to the longer sides LS of other flat square wire coils.

### Annealing Step (Step S17)

Next, the flat square wire coil unit 102 is annealed and deformed into a desired shape as necessary. This deformation is, for example, a deformation for a coating step to be performed later, to separate each turn of the one-turn regions CR and/or to separate the coupling portions 300A and 300B in each of the flat square wire coils 12A to 12C, to such an extent that each turn or each coupling portion can be applied (coated) with a resin. It is also possible to deform the lead-out portion TO (TO1, TO2) to allow connection with a desired terminal, for example.

In addition to the annealing step after the bending step of the coupling portion 300, the annealing step may be performed before the bending step or, instead of the annealing step after the bending step of the coupling portion 300, the annealing step before the bending step may be performed.

### Coating Step (Step S19)

Next, the surface of the conductor of the flat square wire coil unit 102 is coated with an insulating resin. As a result, the coil unit 100 as shown in FIGS. 8(A) and 8(B) is formed. Coating with the insulating resin is performed by electrodeposition coating, for example. Each helical turn of the flat square wire coils 12A to 12C is separated by molding after annealing, which allows sufficient contact (of the surface of one long-length conductor) with a paint solution throughout the entire helical structure. Thus, the respective one-turn regions CR of each helical structure of the flat square wire coils 12A to 12C are insulated from each other. Here, coating with the insulating resin may be performed by spraying insulating resin materials or injection molding of the insulating resin.

In the second embodiment, the configuration of coupling the three flat square wire coils 12A to 12C has been illustrated. However, the number of the flat square wire coils 12 (the original round wire coils 11) to be connected is not limited to this example. For example, a configuration may be adopted in which five flat square wire coils 12 (original round wire coils 11) are coupled through the coupling portion 300.

The step of forming the second-shape coil unit (flat square wire coil unit) 102 (step S13) may be performed after the step of deforming the coupling portion 300 (step S15). Specifically, after the first-shape coil unit 101 is formed (step S11), the coupling portion 300 may be deformed (step S15) to arrange each coil at a desired position, and then the first-shape coil unit 101 is pressed to form the second-shape coil unit 102 (step S13).

Although illustration is omitted, an external connection member is connected to at least one of the lead-out portions TO1 and TO2 of the coil unit 100 (or the flat square wire coil unit 102) as necessary. The external connection member is a terminal or a bus bar, for example. The external connection member can be connected to the lead-out portion TO1 and TO2 by pressure welding (cold pressure welding), in which both end faces are butted and pressed. This connection may be achieved by, for example, welding, or bonding using a conductive adhesive. The external connection member may be a metal material (e.g., a metal material mainly made of aluminum) same as the round wire conductor M0 (e.g., a metal material mainly made of aluminum), or may be a metal material (e.g., a metal material mainly made of copper (such as copper or a copper alloy)) different from the round wire conductor M0. For example, sufficiently long lead-out portions TO1 and TO2 may be secured and deformed into desired shapes in the bending step of the coupling portion 300, and the resultant portions may be used as the external connection members (e.g., a bus bar). This makes it possible to form a bus bar-welded coil unit 100 without separately connecting the external connection member.

In the case of connecting the external connection member to the lead-out portion TO1 and TO2 at a later stage, the connecting operation may be performed, for example, before coating with an insulating resin. Alternatively, after coating with the insulating resin, the insulating resin on the lead-out portions TO1 and TO2 may be removed for the connecting operation.

### Stator Member

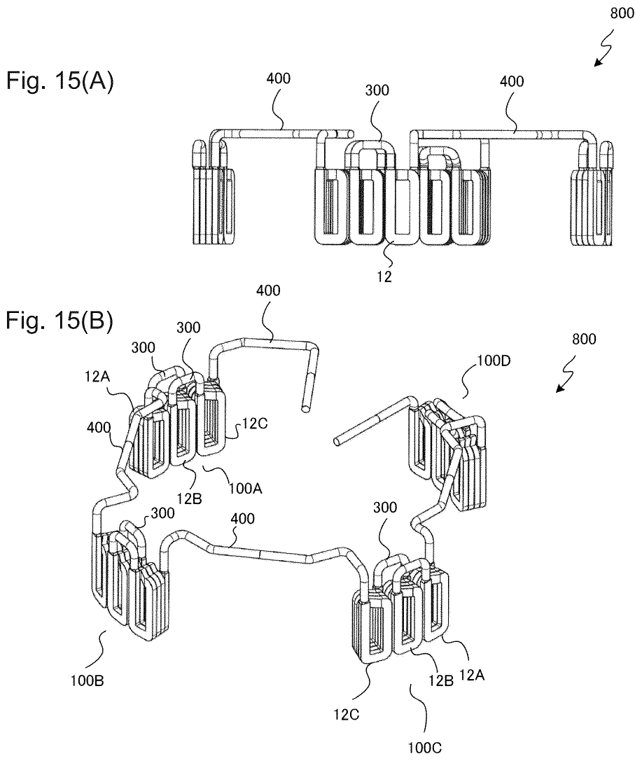

FIGS. 15(A) and 15(B) show an example of a stator member 800 configured by continuously joining the plurality of (four in this case) coil units 100. FIG. 15(A) is a front view of a certain flat square wire coil 12 as viewed from the helical axial direction, and FIG. 15(B) is a perspective view of the flat square wire coil 12.

The four coil units 100 (100A to 100D) are coupled through a connection portion (bus bar) 400. The connection portion 400 can be constituted of conductors that are continuous to the four coil units 100. In other words, when, for example, the number of coils that can be molded by a pair of molding metal molds 61 (see FIG. 11(A)) is set to 12, the four coil units 100 can be molded in the same way as described above. Specifically, one round wire conductor M0 is wound to form, for example, four round wire coil units 101 each constituted of three round wire coils. The round wire coil units 101 are each wound in such a way that the three round wire coils 11 are continuously joined through the coupling portion 300 having a prescribed length as shown in FIGS. 10(A) and 10(B). In addition, the four round wire coil units 101 are each wound so as to be continuous via the connection portion (bus bar) 400 having a prescribed length.

Then, a pair of molding metal molds 61 is used for molding to form four flat square wire coil units 102 by deforming the coupling portion 300. The connection portion 400 is further deformed as necessary. As a result, the stator member 800, with four coil units 100 (100A to 100D) being coupled through the connection portion (bus bar) 400 as shown in FIGS. 15(A) and 15(B), is formed. In this case, the connection portion 400 is made of the same material as the coil units 100, for example.

Alternatively, it is also possible to form the stator member 800 by connecting four flat square wire coil units 102 and the connection portion 400 serving as the external connection member by pressure welding or the like, the four flat square wire coil units 102 being separately formed using the molding metal mold 61 (the metal mold capable of forming the flat square wire coil unit 102 constituted of three flat square wire coils 12) shown in FIGS. 11(A) and 11(B). In this case, the connection portion 400 (external connection member) is connected to the lead-out portion TO of each of the four coil units 100 (100A to 100D). In this case, the connection portion 400 may be made of the same material as the coil unit 100 or made of a different material (e.g., copper).

In each of these cases, the coupling portion 300 and the connection portion 400 are protected by such a component as a spacer or a cover (provided in the metal mold) (not shown) so as not to be pressed.

In the case of forming such a stator member 800, the step of coating with an insulating resin may be performed after the plurality of continuous flat square wire coil units 102 are formed (after the plurality of flat square wire coil units 102 are connected) (step S19).

The plurality of stator members 800 are further formed and attached to an annular stator core (not shown), and thereby a stator with the plurality of flat square wire coils 12 arranged in an annular pattern is constituted. For example, when the three flat square wire coils 12A to 12C constituting one coil unit 100 (or each of the coil units 100) are made to have current or voltage phase different from each other, such as U phase, V phase, and W phase, the stator member 800 for a three-phase motor can be manufactured.

Note that the stator member 800 shown in FIGS. 15(A) and 15(B) is adopted for a radial gap type motor in which the direction of the helical axis AX of the flat square wire coil 12 is orthogonal to the axial direction of the motor. However, without limited thereto, the manufacturing method of the coil unit 100 of the present embodiment makes it possible to form the stator member that is adopted for an axial gap type motor in which the direction of the helical axis AX of the flat square wire coil 12 is parallel to the axis direction of the motor, by appropriately changing the shape (winding method or arrangement) of the round wire coil unit 101 as shown in FIGS. 10(A) and 10(B) and the mode of deformation of the coupling portion 300 as shown in FIGS. 12(A)-12(E).

In the present embodiments (first embodiment and second embodiment), the case where the first-shape coils are the round wire coils 11 and the second-shape coils are flat square wire coils 12 have been described. However, the first-shape coils and the second-shape coils are not limited to the above-mentioned examples, as long as they are different in cross sectional shape and/or size (cross-sectional area) of the conductor. This will be described below.

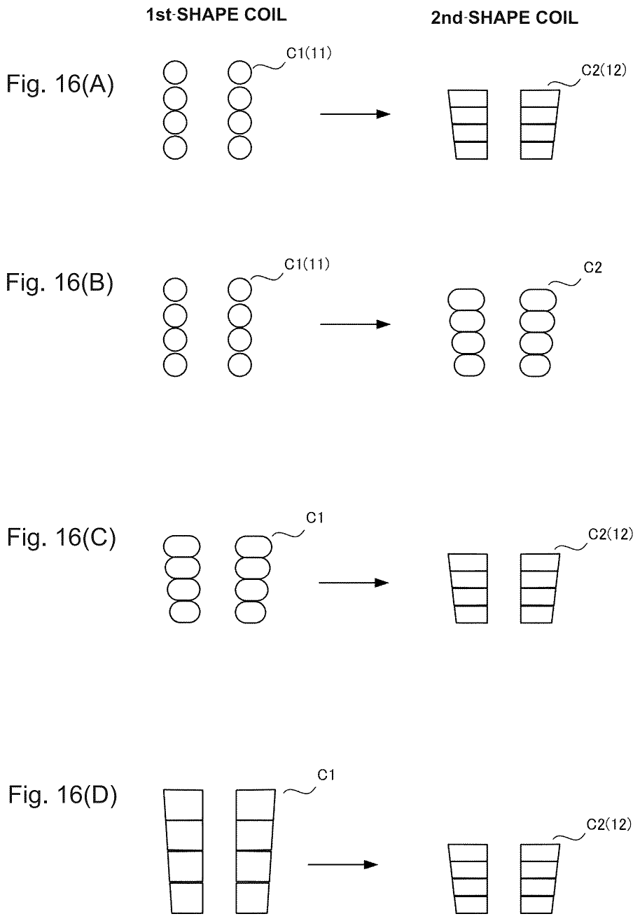

FIGS. 16(A)-16(D) include schematic views for describing the first-shape coil C1 and the second-shape coil C2 of the present embodiment, which are schematic cross-sectional views corresponding to the line X-X in FIG. 2(B). In FIGS. 16(A) to 16(D), the left side shows examples of the first-shape coil C1, and the right side shows examples of the second-shape coil C2.

FIG. 16(A) shows an example of the present embodiments described above. In other words, the first-shape coil C1 is the round wire coil 11 having the cross sectional shape of the conductor being substantially circular, and the round wire coil 11 is pressed by the molding metal mold 51 or 61 to form the flat square wire coil 12 having the cross sectional shape of the conductor being substantially rectangular as the second-shape coil C2.

FIG. 16(B) shows another example, in which the first-shape coil C1 may be the round wire coil 11 having the cross sectional shape of the conductor being substantially circular, and the round wire coil 11 may be pressed by the molding metal mold 51 or 61 to form a flat round wire coil having the cross sectional shape of the conductor being elliptic (oval) as the second-shape coil C2.

FIG. 16(C) shows still another example, in which the first-shape coil C1 may be a flat round wire coil having the cross sectional shape of the conductor being elliptic (oval), and the flat round wire coil may be pressed by the molding metal mold 51 or 61 to form a flat square wire coil having the cross sectional shape of the conductor being substantially rectangular as the second-shape coil C2.

FIG. 16(D) shows yet another example, in which the first-shape coil C1 may be a square wire coil having the cross sectional shape of the conductor being thick and substantially rectangular (substantially square or polygonal), and the square wire coil may be pressed by the molding metal mold 51 or 61 to form the flat square wire coil 12 having a cross sectional shape of the conductor being substantially rectangular (or polygonal) as the second-shape coil C2.

Note that the outer shapes of the first-shape coil C1 and the second-shape coil C2 are not limited to those shown in FIGS. 16(A)-16(D), and in each of those cases, their outer shapes may be a substantially rectangular parallelepiped or a substantially truncated square pyramid.

According to the present embodiment as described above, it is possible to form a high-precision flat square wire coil 12 that is rectangular in plan view by winding the round wire conductor M0 in a helical form and pressing the round wire conductor M0 in the direction of the helical axis AX by the molding metal mold. The flat square wire coil 12 having a rectangular shape in plan view (having corner portions at substantially right angles in plan view) can improve the space factor when the flat square wire coil 12 is mounted on a stator and therefore contributes to higher performance of the motor. In short, the flat square wire coil 12 suitable as a motor component can be manufactured by simple apparatuses and steps without the need for complicated steps and apparatuses, making it possible to reduce manufacturing costs and to improve productivity (mass production speed).

Note that at least part of the coupling portion 300 and/or the connection portion 400 may be pressed (in a same way as the coil).

In addition, in the step of forming the flat square

wire coil unit (second-shape coil unit) 102, the case of pressing the three round wire coils (first-shape coils) 11A to 11C at the same timing using, for example, the molding metal mold 61 shown in FIGS. 11(A) and 11(B) has been illustrated. However, without being limited to the case, the three round wire coils 11A to 11C may be pressed at different timing. Specifically, for example, a molding metal mold capable of forming one square wire coil 12 may be used, and the three round wire coils 11A to 11C may individually be set in the molding metal mold and be pressed in sequence to form the flat square wire coil unit 102.

Again, the conductor (for example, the round wire conductor M0) in the present embodiment is, for example, a metal material having copper as a main component or a metal material having aluminum as a main component. The conductor may be constituted of a plurality of metal materials connected in the longitudinal direction, for example, the end face of a metal material having copper as a main component and the end face of a metal material having aluminum as a main component are pressed and continuously joined (and this operation is repeated once or a plurality of times) to form one conductor.

In other words, the metal material of the coil (first-shape coil C1 and round wire coil 11) may be changed in the middle of winding. The plurality of coils that constitute the coil unit 100 may also be constituted of different metal materials.

Moreover, in the case of molding the first-shape coil C1 (round wire coil 11) into the second-shape coil C2 (flat square wire coil 12), a plurality of pressing steps may be performed using two or more molding metal molds different in shape and size.

Furthermore, in the above-described embodiments, the case where the first-shape coil C1 (round wire coil 11) and the second-shape coil C2 (flat square wire coil 12) are concentrated winding coils obtained by winding a conductor in a helical form has been illustrated. However, without being limited to this case, the first-shape coil C1 and the second-shape coil C2 may be so-called distributed winding coils or wave winding coils, obtained by winding the conductor so that the winding region (one-turn region CR) around the virtual axis is shifted in one direction (for example, a circumferential direction of the stator).

Note that the present invention is not limited to the above-described embodiments, and it goes without saying that various modifications can be made without departing from the gist of the present invention.

1. A manufacturing method of a coil, comprising:
a step of winding a round wire conductor to form a round wire coil; and
a step of pressing the round wire coil with a molding metal mold to form a flat square wire coil having one turn in a substantially rectangular shape.

2. The manufacturing method of a coil according to claim 1, comprising a step of coating a surface of the flat square wire coil with an insulating resin.

3. The manufacturing method of a coil according to claim 1, wherein:
the molding metal mold includes a first metal mold and a second metal mold that can move relative to each other;
a molding region defined by the first metal mold and the second metal mold is in a shape of a substantially rectangular frame having shorter side portions, corner portions, and longer side portions in plan view; and
the method comprises a step of pressing the round wire coil while the round wire coil is housed in the molding region.

4. The manufacturing method of a coil according to claim 3, wherein a width of the corner portion is larger than a width of the longer side portion.

5. The manufacturing method of a coil according to claim 3, wherein a width of the shorter side is larger than a width of the longer side portion.

6. A manufacturing method of a coil unit, comprising:
a step of winding a conductor to form a first-shape coil unit including a coupling portion and a plurality of first-shape coils that have been coupled through the coupling portion; and
a step of pressing the first-shape coil unit with a molding metal mold to form a second-shape coil unit including a plurality of second-shape coils joined continuously.

7. The manufacturing method of a coil unit according to claim 6, wherein the first-shape coil and the second-shape coil are coils that are pressed to be different in cross-sectional shape.

8. The manufacturing method of a coil unit according to claim 6, wherein the first-shape coil is a round wire coil, and the second-shape coil is a substantially flat square wire coil.

9. The manufacturing method of a coil unit according to claim 6, wherein the second-shape coil is formed to have one turn in a substantially rectangular shape.

10. The manufacturing method of a coil unit according to claim 6, comprising a step of deforming at least one coil, out of the plurality of second-shape coils, so as to move relatively to other coils.

11. The manufacturing method of a coil unit according to claim 10, comprising a step of deforming the coupling portion so that the one coil is adjacent to the other coils.

12. The manufacturing method of a coil unit according to claim 10, wherein the second-shape coil unit is coated with a resin after deforming.

13. The manufacturing method of a coil unit according to claim 6, wherein annealing is performed after the second-shape coil unit has been molded.

14. The manufacturing method of a coil according to claim 4, wherein a width of the shorter side is larger than a width of the longer side portion.

15. The manufacturing method of a coil unit according to claim 11, wherein the second-shape coil unit is coated with a resin after deforming.
